(19) United States
(12) Patent Application Publication
(10) Pub. No.: US 2010/0300664 A1
(43) Pub. Date: Dec. 2, 2010

(54) HEAT EXCHANGER

(76) Inventors: YoungMook Kang, Chungnam (KR); YongSoo Kim, Chungnam (KR); Frederick Urfer, Delafield, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/744,730

(22) PCT Filed: Jan. 10, 2008
(86) PCT No.: PCT/US08/50766

§ 371 Date: May 26, 2010

(51) Int. Cl. F28D 7/00; F28F 9/02; F28F 1/14; B23P 15/26

(52) U.S. Cl. 165/157; 165/173; 165/183; 29/890.052

(57) ABSTRACT

A heat exchanger, a reinforced header assembly for use in a heat exchanger, and a method of assembling a heat exchanger. The reinforced header assembly may include a header connectable with a tank to define a collection tank assembly, the header including a central portion defining a plurality of header openings, and a connecting portion connectable to the end of the tank wall such that the tank portion and the header cooperate to define the collection tank assembly, the connecting portion including a wall extending at a non-parallel angle relative to the central portion, and a reinforcement member including an inner portion defining a plurality of member openings, and an outer portion extending at a non-parallel angle relative to the inner portion, the outer portion being complementary to and connected to at least a portion of the wall of the connecting portion of the header.

### BACKGROUND

A variety of heat exchangers exist in which a number of tubes are connected to and in fluid communication with a collection tank for introducing and/or removing fluid from the tubes. In many cases, the applications of such heat exchangers result in high pressure and thermal stresses, such as in locations at and adjacent to the connections of the flat tubes to the collection tank. Also, it is desirable for such collection tanks and the connections of the flat tubes thereto to withstand significant pressure without excessive deformation or damage—despite the desire to construct the heat exchanger and the collection tanks from increasingly thinner and lighter materials. Particularly in cases in which the collection tanks are constructed of multiple parts (e.g., a header plate and a structure defining the remainder of the collection tank), this capability should extend to the interface between the collection tank parts.

### SUMMARY

Some existing heat exchangers may include a tank and a header cooperating to define a collection tank assembly, and a core including tubes connected to the header to fluidly connect the core to the collection tank. When flat tubes are used, the stresses may be increased in the area adjacent the narrow side(s) of the tubes. Due to thermal and/or pressure stresses and cycling, a crack may develop in the area between the connection of the tubes to the header and the connection of the header to the tank, especially when that area is proximate the narrow side(s) of the tubes.

It will be appreciated that heat exchangers having collection tanks and collection tank-to-flat tube joints adapted to withstand thermal and/or pressure stresses and cycling are welcome additions to the industry, as are heat exchangers that are relatively light weight and that can be produced more efficiently and at a lower cost.

Some independent embodiments of the present invention provide a heat exchanger including a reinforced header assembly. The assembly may generally include a header connectable with a tank to define a collection tank assembly and a reinforcement member. The header may include a central portion defining a plurality of header openings, each header opening being connectable to one opposite end of an associated tube such that the tube is in fluid communication with the collection tank assembly, and a connecting portion extending away from the central portion and connectable to the end of the tank wall such that the tank portion and the header cooperate to define the collection tank assembly, the connecting portion including a wall extending at a non-parallel angle relative to the central portion. The reinforcement member may include an inner portion defining a plurality of member openings, at least one of the plurality of tubes extending through each member opening to connect with the header, and an outer portion extending at a non-parallel angle relative to the inner portion, the outer portion being complementary to and connected to at least a portion of the wall of the connecting portion of the header.

The tubes can have any cross-section shape desired. However, unique advantages can be achieved by the use of flat tubes (i.e., tubes having opposing substantially broad flat sides joined by opposing narrow sides) connected to the header. In such constructions, the outer portion of the reinforcement member may be positioned along a row of tubes adjacent the narrow side of the tubes.

Other independent embodiments of the present invention provide a method of assembling a heat exchanger including a reinforced header assembly.

By virtue of the reinforced header as described above, it is possible, in some embodiments, to achieve increased strength and/or durability of the header and of the connections between the header and tubes and between the header and the tank. The increased mechanical strength, durability, etc. also increases the service life of a collection tank and heat exchanger having such a header. Such advantages do not necessarily require any additional expenditure with regard to the header and collection tank material, the number of header and collection tank components, and the individual production stages of the header and collection.

Still other independent aspects of the invention will become apparent by consideration of the detailed description and accompanying drawings.

### BRIEF DESCRIPTION OF THE DRAWINGS

FIG. 1 is a perspective exploded view of a heat exchanger according to an independent embodiment of the present invention.

FIG. 2 is a perspective view of a reinforced header shown in FIG. 1.

FIG. 3 is a partial cross-sectional view of the reinforced header assembly taken generally along line 3-3 in FIG. 2.

FIG. 4 is an enlarged partial cross-sectional view of a portion of the reinforced header assembly shown in FIG. 3.

FIG. 5 is a perspective view of a portion of the heat exchanger shown in FIG. 1.

FIG. 6 is a view of an alternative construction for a reinforced header assembly.

FIG. 7 is a view of another alternative construction for a reinforced header assembly.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

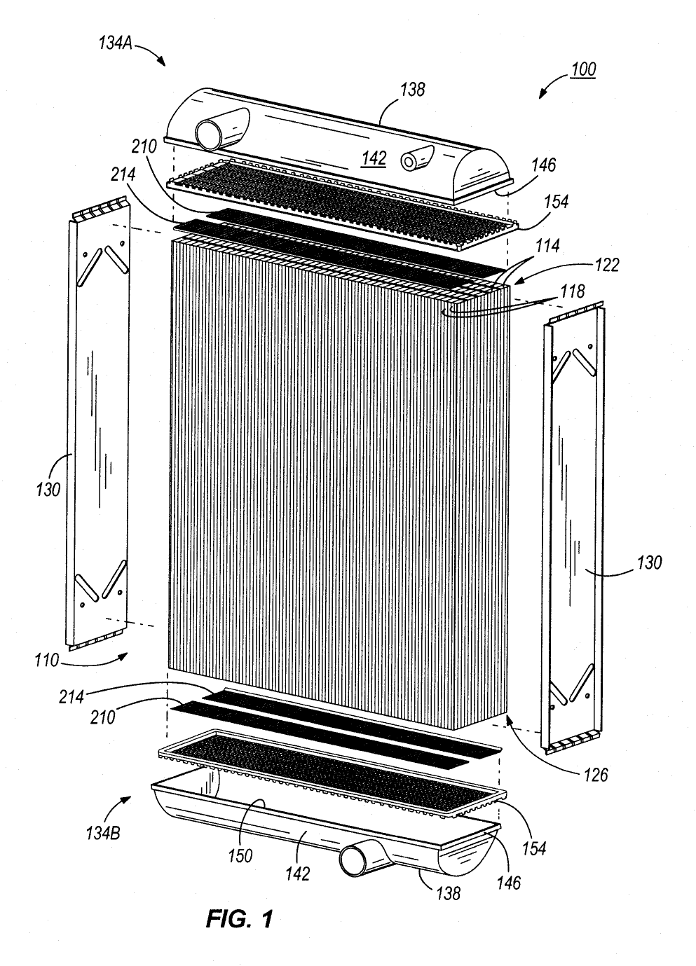

FIG. 1 illustrates a heat exchanger 100. The heat exchanger 100 is suitable for any application in which heat exchange takes place with fluid passing through a collection tank. Such applications exist in vehicle systems (including, for example, off-highway heavy construction equipment), such as those used in conjunction with internal combustion engines as, for example, a high capacity radiator. In some applications, for example, the heat exchanger 100 can function as a cooler, as a condenser, or as an evaporator. Also, in some applications, the heat exchanger 100 can be connected to exchange heat in a refrigerant circuit.

The heat exchanger 100 includes a core 110 including tubes 114 and fins 118. The tubes 114 have opposite ends 122 and 126. The tubes 114 can have any cross-section shape desired. However, unique advantages can be achieved by the use of flat tubes (i.e., tubes having opposing substantially broad flat sides joined by opposing narrow sides), and, in the illustrated construction, the tubes 114 are flat tubes. Side plates 130 cover the side portions of the core 110.

In the illustrated construction, the core 110 includes five rows of tubes 114. It should be understood that, in other constructions (not shown), the core 110 may have fewer or more than five rows of tubes 114, based on, for example, the design requirements of the heat exchanger 110.

In the illustrated construction, the heat exchanger 100 also includes collection tank assemblies 134A and 134B. The collection tank assemblies 134A and 134B are similar, and only the first or upper collection tank assembly 134A will be explained in detail. Common elements of the second or lower collection tank assembly 134B have the same reference number.

The collection tank assembly 134A includes a tank 138 having a tank wall 142. The tank wall 142 has an end 146 and at least partially defines a cavity 150 (shown for the lower tank 138). A header 154 is connectable to and cooperates with the tank 138 to provide the collection tank assembly 134A.

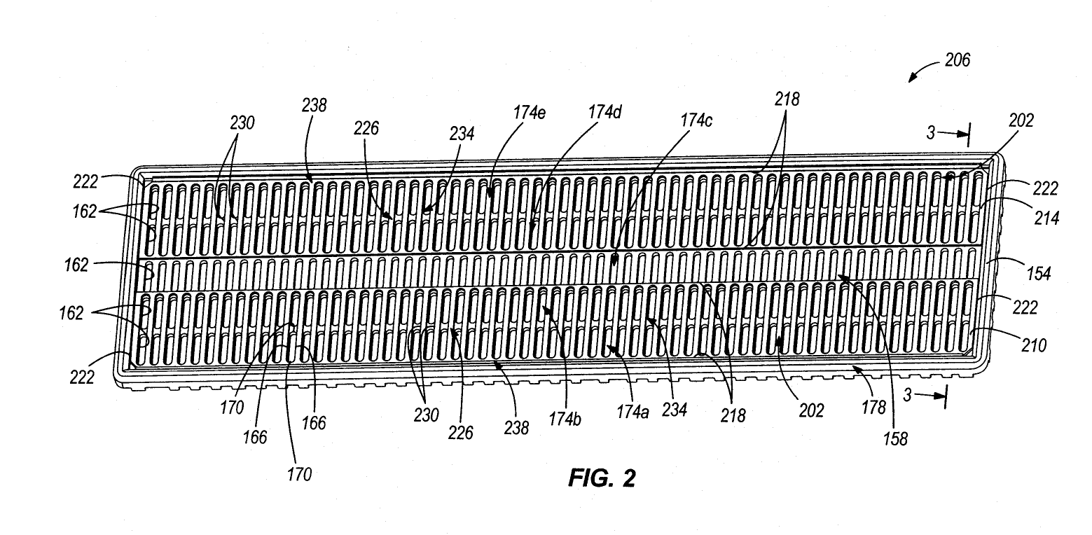

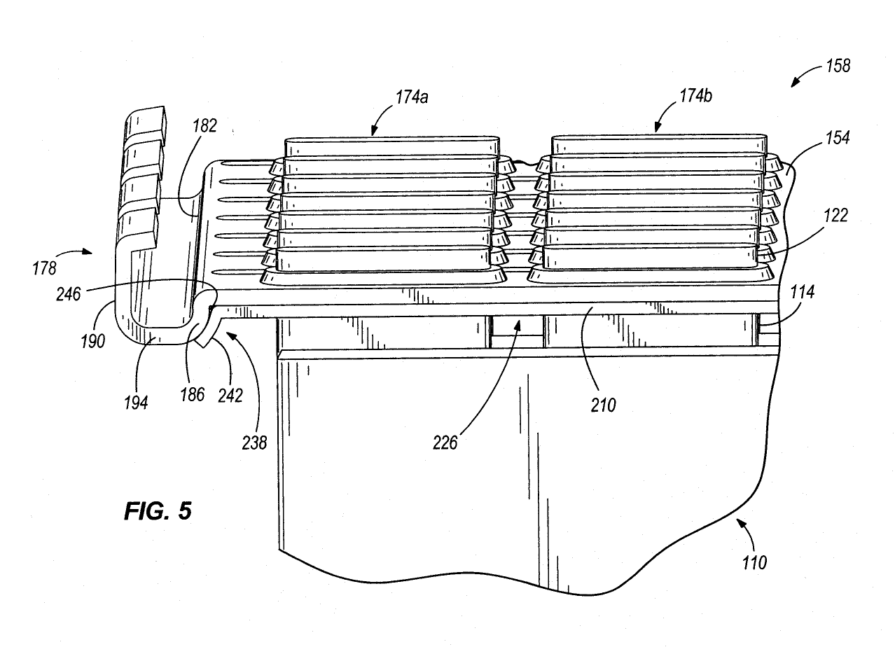

As shown in more detail in FIGS. 2-5, the header 154 has a central portion 158 defining openings 162 for connection with the tubes 114 of the core 110 to connect the tubes 114 to the collection tank assembly 134A. The openings 162 correspond in number to the tubes 114, and each opening 162 is connected to and has a shape which is complementary to an associated tube 114. In the illustrated construction including the flat tubes 114, each opening 162 is slot-shaped and has opposed broad sides 166 connected by opposed narrow sides 170.

The flat tubes 114 are received within the slot-shaped openings 162 in the header 154. The tubes 114 can be fastened to the header 154 in a pressure-tight manner by soldering, welding, brazing, adhesive or cohesive bonding material, with grommets, or in any other suitable manner.

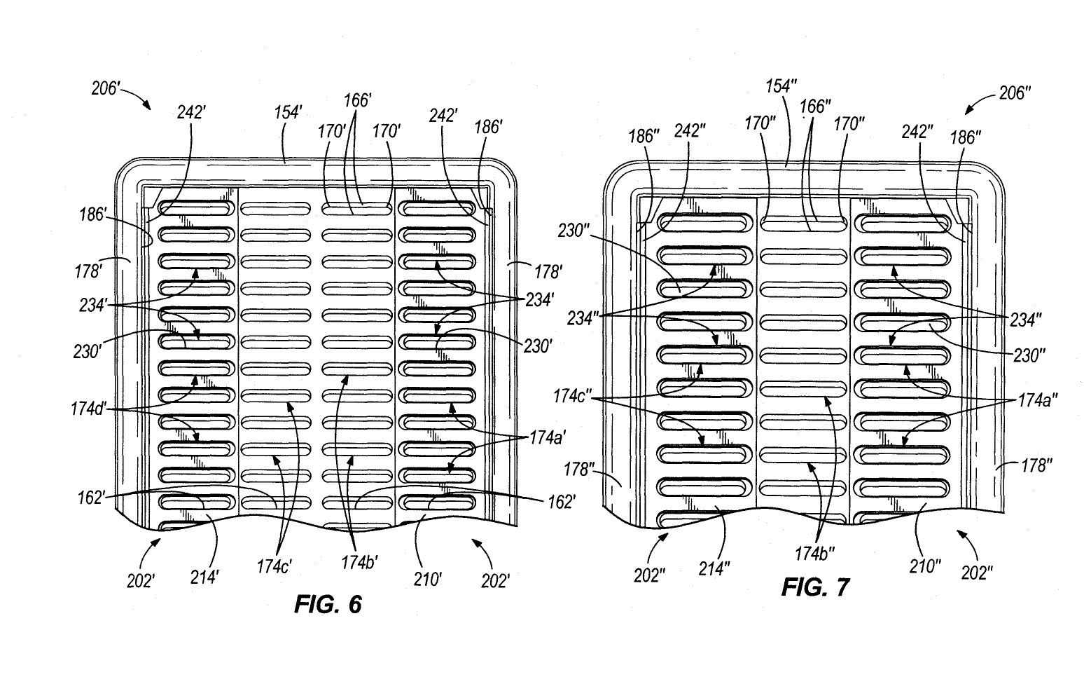

The openings 162 are arranged on the central portion 158 in one or more rows 174 of openings 162. In the illustrated construction, five rows 174a, b, c, d, e are provided on the header 154 corresponding to the number of rows of tubes 114 in the core 110. It should be understood that, in other constructions, the header 154 may include fewer than five rows 174 of openings 162 (e.g., four rows 174′ (as shown in FIG. 6), three rows 174″ (as shown in FIG. 7), two rows or one row) or more than five rows 174 of openings 162 (not shown) based on the design of the heat exchanger 100 (e.g., the number of rows of tubes 114).

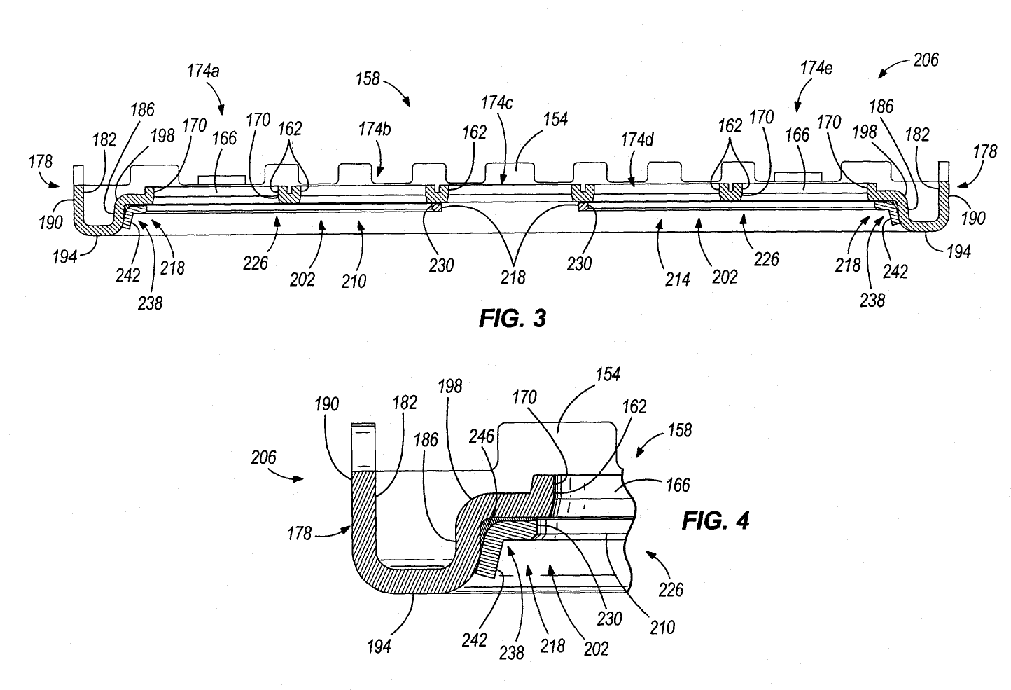

The header 154 also includes a connecting portion 178 to connect the header 154 to the tank 138. In the illustrated construction, the connecting portion 178 generally extends away from and about at least a portion of the periphery of the central portion 158. The connecting portion 178 defines (see FIGS. 3-5) a channel 182 for receiving the end 146 of the tank wall 142. The channel 182 is defined by an inner wall 186, an outer wall 190, and an end wall 194 connected between the walls 186 and 190.

As shown in FIGS. 3-5, the inner wall 186 extends at a non-parallel angle relative to the adjacent central portion 158. In the illustrated construction, after a curved transition region 198, a portion of the inner wall 186 is oriented at about a perpendicular angle (e.g., about 90° with respect to the central portion 158. Generally, the non-parallel angle will be an angle enabling the inner wall 186 to cooperate in defining the channel 182 and/or the connecting portion 178 to be operable to connect the header 154 and the tank 138. However, it should be understood that, in other constructions (not shown), the non-parallel angle may be any other non-parallel angle.

The tank 138 can be secured to the header 154 in a number of different manners, some of which provide a degree of resistance to fluid leakage under internal collection tank pressures. The tank 138 and the header 154 can be secured by connecting the end 138 of the tank wall 142 in the channel 182 of the connecting portion 178 by welding, soldering, brazing, etc.

In some constructions, the tank 138 may be made of plastic, and the header 154 is made of aluminum, steel, iron, or other metal. Although this material combination provides unique performance results (including a thin-walled but strong header 154 able to withstand significant pressures, while permitting the use of a less expensive and/or easy to manufacture tank 138), other materials and material combinations are possible. For example, in other constructions, both the tank 138 and the header 154 are made of plastic. As another example, in other constructions, both the tank 138 and the header 154 are made of metal. Alternatively, in still other constructions, the tank 138 is made of metal, while the header 154 is made of plastic.

To prevent leakage of fluid out of the collection tank assembly 134A, a gasket (not shown) is located between the tank 138 and the header 154. The gasket extends about the periphery of the tank 138 and the header 154, and can be made of rubber, plastic, or any other material suitable for forming a seal.

The heat exchanger 100 also includes reinforcement 202 for the header 154 to provide a reinforced header assembly 206. The reinforcement 202 includes at least one and, in the illustrated construction, two reinforcement members or reinforcement plates 210 and 214. The reinforcement members 210 and 214 are substantially the same (though illustrated and positioned in reversed orientations), and only the reinforcement member 210 will be explained in detail. Common elements of the reinforcement member 214 have the same reference number.

The reinforcement member 210 generally has opposed longitudinal sides 218 connected by opposed lateral sides 222. The reinforcement member 210 includes an inner portion 226 generally overlying at least a portion of the central portion 158 of the header 154. The inner portion 226 defines a number of openings 230 such that the structure of the inner portion 226 does not interfere with engagement between the tubes 114 and the openings 162 in the header 154. In the illustrated construction, each opening 230 is slot-shaped and spans, in a lateral direction, an opening 162 in two adjacent rows (e.g., 174a, 174b), and the two associated tubes 114 would pass through the opening 230 to the openings 162 to connect to the header 154.

In other constructions, the opening 230 may span only a single opening 162 (as shown in FIGS. 6-7) or may span an opening 162 in more than two adjacent rows 174 (not shown). Also, the opening 230 may span, in a longitudinal direction, more than one opening 162 in a row or adjacent rows 174 (not shown).

The openings 230 are arranged on the inner portion 226 in one or more rows 234 of openings 230. In the illustrated construction, one row 234 is provided on the reinforcement member 210. It should be understood that, in other constructions, the header reinforcement member 210 may include more than one row 234 of openings 230 based, for example, on the design of the heat exchanger 100 (e.g., the number of rows of tubes 114) and the header 154 (e.g., the number of rows 174 of header openings 162).

In the illustrated construction, the reinforcement member 210 also includes an outer portion 238 on the outer longitudinal side 218. As shown in FIGS. 3-5, the outer portion 238 includes a wall 242 which extends at a non-parallel angle relative to the inner portion 226. The angle of the wall 242 is generally complementary to the angle of the wall 186 such that the wall 242 is connectable to the wall 186 to at least partially connect the reinforcement member 210 to the header 154. In the illustrated construction, the non-parallel angle between the wall 242 and the inner portion 226 is about 70°. Generally, the non-parallel angle will be an angle enabling the wall 242 to connect with the inner wall 186.

To connect the reinforcement 202 to the header 154, the reinforcement member(s) 210, 214 may be initially welded (e.g., by ultra-sonic welding) to the header 154 at several points, for example, for pre-assembly. As shown in FIG. 4, brazing material 246 is provided between the reinforcement member(s) 210, 214 and the header 154, and the components are brazed to complete the connection.

It should be understood that, in other constructions (not shown), different and/or additional connection methods/structures may be provided to connect the reinforcement member(s) 210, 214 and the header 154. The reinforcement member(s) 210, 214 can be connected to the header 154 in any manner desired, including without limitation by brazing or welding, by clips, by Tox® rivets (Tox Pressotechnik GmbH & Co. KG), or in any other manner desired. Also, structure may be provided on the header 154 and the reinforcement member(s) 210, 214 to provide a clearance fit, snap fit, press fit, or another mating arrangement. The mating relationship can enable accurate placement of the reinforcement member(s) 210, 214 with respect to the header 154.

The reinforcement member(s) 210, 214 can be made of any suitable material, including without limitation aluminum, steel, iron, and other metals, composite materials, etc., and can be manufactured in any suitable manner, including without limitation casting, stamping, pressing, deep drawing, extruding, machining, etc.

It should be understood that, in other constructions (not shown), the reinforcement 202 may include a single reinforcement member 210 including an outer portion 238 with an angled wall 242 on each longitudinal side 218 (e.g., a combination of reinforcement members 210 and 214). It should also be understood that the reinforcement 202 may include an outer portion (similar to the outer portion 238 with an angled wall 242) on one or both lateral sides 222.

As discussed above, when flat tubes 114 are used in the heat exchanger 100, the stresses may be increased in the area adjacent the narrow side(s) of the tubes 114. Due to thermal and/or pressure stresses and cycling, a crack may be more likely to develop in the area between the connection of the tubes 114 to the header 154 and the connection of the header 154 to the tank 138, especially when that area is proximate the narrow side(s) of the tubes 114. To reduce the likelihood of such a crack developing, the reinforcement member 210, 214 provides additional structural support across this area of the header 154, from the narrow side of the tubes 114 in the outer row 174a (and the narrow side 170 of each associated opening 162) and along the curved transition region 198 and at least a portion of the angled wall 186. The arrangement of the reinforcement member 210, 214 may also tend to dissipate the thermal and pressure stresses and effects of cycling across a larger area of the header 154 and the reinforcement member 210, 214.

Therefore, it is possible to reduce the cross-sectional thickness of the individual components of the collection tank assembly 134A to achieve weight and cost savings. As a result of the increase in the mechanical strength and durability of the header 154 (and more generally, of the collection tank assembly 134A), the service life of the collection tank assembly 134A and of a correspondingly configured heat exchanger 100 is increased without any significant additional material expenditures, heat exchanger components, or individual production steps.

FIGS. 6-7 illustrate alternative constructions of a reinforced header assembly 206′ and 206″, respectively. The reinforced header assemblies 206′ and 206″ are substantially similar to the reinforced header assembly 206 illustrated in FIGS. 1-5, and common elements have the same reference number “′” and “″”, respectively.

As shown in FIGS. 1-5, the reinforced header assembly 206 includes a header 154 having five rows 174 of openings 162 and two reinforcement members 210, 214, each having a row of openings 230 spanning two rows 174 of header openings 162. As shown in FIG. 6, the header 206′ has four rows 174′ of openings 162′, and two reinforcement members 210′, 214′, each having a row of openings 230′ spanning one row 174′ of header openings 162′. As shown in FIG. 7, the header 206″ has three rows 174″ of openings 162″, and two reinforcement members 210″, 214″, each having a row of openings 230″ spanning one row 174″ of header openings 162″.

As mentioned above, it should be understood that, in other constructions, the header 154 may have a different number of rows 174 of openings 162 based on the design of the heat exchanger 100 (e.g., the number of rows of tubes 114). As also mentioned above, it should be understood that, in other constructions, the opening 230 may span a different number of header openings 162, in the lateral direction (e.g., in more than one row 174 of header openings 162) and/or in the longitudinal direction (e.g., in the same row 174 of header openings 162).

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

What is claimed is:

1. A heat exchanger comprising:
a core including
a plurality of tubes having opposite ends, and
a plurality of fins extending between associated ones of the plurality of tubes;
a tank including a tank wall at least partially defining a cavity and having an end;
a header connectable with the tank to define a collection tank assembly, the header including
a central portion defining a plurality of header openings, each header opening being connectable to one opposite end of an associated tube such that the tube is in fluid communication with the collection tank assembly, and
a connecting portion extending away from the central portion and connectable to the end of the tank wall such that the tank portion and the header cooperate to define the collection tank assembly, the connecting portion including a wall extending at a non-parallel angle relative to the central portion; and
a reinforcement member connectable to the header, the reinforcement member including
an inner portion defining a plurality of member openings, at least one of the plurality of tubes extending through each member opening to connect with the header, and
an outer portion extending at a non-parallel angle relative to the inner portion, the outer portion being complementary to and connected to at least a portion of the wall of the connecting portion of the header.

2. The heat exchanger of claim 1, wherein the connecting portion defines a channel receiving the end of the tank wall, the first-mentioned wall providing an inner wall of the channel, the connecting portion including an outer wall and an end wall connected between the first-mentioned wall and the outer wall, the first-mentioned wall, the outer wall and the end wall cooperating to define the channel.

3. The heat exchanger of claim 1, wherein each header opening is a slot having a opposed broad sides connected by opposed narrow sides, wherein the plurality of header openings is arranged in at least one row of header openings having a length, the narrow sides of each slot being along the length of the row, and wherein the outer portion of the reinforcement member is arranged at least along the length of the row.

4. The heat exchanger of claim 3, wherein the outer portion of the reinforcement member is arranged on one side of the row of header openings.

5. The heat exchanger of claim 1, wherein the reinforcement member has opposed longitudinal sides connected by opposed lateral sides, wherein the outer portion of the reinforcement member extends along at least one longitudinal side of the reinforcement member.

6. The heat exchanger of claim 1, wherein the plurality of header openings is arranged in a first row of header openings and a parallel second row of header openings, and wherein the inner portion of the reinforcement member is positioned to overlay a portion of the header defining the first row of header openings and to not overlay the portion of the header defining the second row of header openings.

7. The heat exchanger of claim 6, wherein the member openings are arranged in a row of member openings, the row of member openings being aligned the first row of header openings.

8. The heat exchanger of claim 6, and further comprising a second reinforcement member positioned to overlay a portion of the header defining the second row of header openings and to not overlay the portion of the header defining the first row of header openings, the second reinforcement member including
an inner portion defining a plurality of second member openings, at least one of the plurality of tubes extending through each second member opening to connect with the header, and
an outer portion extending at a non-parallel angle relative to the inner portion, the outer portion being complementary to and connected to at least another portion of the wall of the connecting portion of the header.

9. The heat exchanger of claim 1, wherein the plurality of header openings is arranged in a first outer row of header openings, an inner row of header openings, and a second outer row of header openings, and wherein the reinforcement member is positioned to overlay a portion of the header defining the first outer row of header openings and to not overlay the portion of the header defining the second outer row of header openings.

10. The heat exchanger of claim 9, wherein the reinforcement member is arranged to overlay the portion of the header defining the inner row of header openings.

11. The heat exchanger of claim 9, and further comprising a second reinforcement member positioned to overlay a portion of the header defining the second outer row of header openings and to not overlay the portion of the header defining the first row of header openings, the second reinforcement member including
an inner portion defining a plurality of second member openings, at least one of the plurality of tubes extending through each second member opening to connect with the header, and
an outer portion extending at a non-parallel angle relative to the inner portion, the outer portion being complementary to and connected to at least another portion of the wall of the connecting portion of the header.

12. The heat exchanger of claim 11, wherein the plurality of header openings is arranged in the first outer row of header openings, the first-mentioned inner row of header openings, a second inner row of header openings, and the second outer row of header openings.

13. The heat exchanger of claim 12, wherein the first-mentioned reinforcement member is positioned to overlay the portion of the header defining the first outer row of header openings and to not overlay the portion of the header defining the first-mentioned inner row of header openings, the second inner row of header openings, and the second outer row of header openings, and wherein second reinforcement member is positioned to overlay the portion of the header defining the second outer row of header openings and to not overlay the portion of the header defining the first outer row of header openings, the first-mentioned inner row of header openings, and the second inner row of header openings.

14. The heat exchanger of claim 12, wherein the plurality of header openings is arranged in the first outer row of header openings, the first-mentioned inner row of header openings, a central row of header openings, the second inner row of header openings, and the second outer row of header openings, wherein the first-mentioned reinforcement member is positioned to overlay the portion of the header defining the first outer row of header openings and the first-mentioned inner row of header openings and to not overlay the second inner row of header openings, the central row of header openings, and the second outer row of header openings, and wherein second reinforcement member is positioned to overlay the portion of the header defining the second outer row of header openings and the second inner row of header openings and to not overlay the portion of the header defining the first outer row of header openings, the first-mentioned inner row of header openings, and the central row of header openings.

15. The heat exchanger of claim 1, and further comprising:
a second tank including a tank wall at least partially defining a cavity and having an end;
a second header connectable with the second tank to define a second collection tank assembly, the second header including
a central portion defining a plurality of header openings, each header opening being connectable to another opposite end of an associated tube such that the tube is in fluid communication with the second collection tank assembly, and
a connecting portion extending away from the central portion and connectable to the end of the tank wall such that the second tank portion and the second header cooperate to define the second collection tank assembly, the connecting portion including a wall extending at a non-parallel angle relative to the central portion; and
a second reinforcement member including
an inner portion defining a plurality of second member openings, at least one of the plurality of tubes extending through each second member opening to connect with the second header, and
an outer portion extending at a non-parallel angle relative to the inner portion, the outer portion being complementary to and connected to at least a portion of the wall of the connecting portion of the second header.

16. A reinforced header assembly for use in a heat exchanger, the heat exchanger including a core including a plurality of tubes having opposite ends, and a plurality of fins extending between associated ones of the plurality of tubes, and a tank including a tank wall at least partially defining a cavity and having an end, the assembly comprising:
a header connectable with the tank to define a collection tank assembly, the header including
a central portion defining a plurality of header openings, each header opening being connectable to one opposite end of an associated tube such that the tube is in fluid communication with the collection tank assembly, and
a connecting portion extending away from the central portion and connectable to the end of the tank wall such that the tank portion and the header cooperate to define the collection tank assembly, the connecting portion including a wall extending at a non-parallel angle relative to the central portion; and
a reinforcement member including
an inner portion defining a plurality of member openings, at least one of the plurality of tubes extending through each member opening to connect with the header, and
an outer portion extending at a non-parallel angle relative to the inner portion, the outer portion being complementary to and connected to at least a portion of the wall of the connecting portion of the header.

17. The assembly of claim 16, wherein each header opening is a slot having a opposed broad sides connected by opposed narrow sides, wherein the plurality of header openings is arranged in at least one row of header openings having a length, the narrow sides of each slot being along the length of the row, and wherein the outer portion of the reinforcement member is arranged at least along the length of the row.

18. The assembly of claim 17, wherein the outer portion of the reinforcement member is arranged on one side of the row of header openings.

19. The assembly of claim 16, wherein the reinforcement member has opposed longitudinal sides connected by opposed lateral sides, wherein the outer portion of the reinforcement member extends along at least one longitudinal side of the reinforcement member.

20. The assembly of claim 16, wherein the plurality of header openings is arranged in a first row of header openings and a parallel second row of header openings, and wherein the inner portion of the reinforcement member is positioned to overlay a portion of the header defining the first row of header openings and to not overlay the portion of the header defining the second row of header openings.

21. The assembly of claim 20, wherein the member openings are arranged in a row of member openings, the row of member openings being aligned the first row of header openings.

22. The assembly of claim 20, and further comprising a second reinforcement member positioned to overlay a portion of the header defining the second row of header openings and to not overlay the portion of the header defining the first row of header openings, the second reinforcement member including
an inner portion defining a plurality of second member openings, at least one of the plurality of tubes extending through each second member opening to connect with the header, and
an outer portion extending at a non-parallel angle relative to the inner portion, the outer portion being complementary to and connected to at least another portion of the wall of the connecting portion of the header.

23. A method of assembling a heat exchanger, the heat exchanger including a core including a plurality of tubes having opposite ends, and a plurality of fins extending between associated ones of the plurality of tubes, a first tank including a tank wall at least partially defining a cavity and having an end, a first header including a central portion defining a plurality of first header openings, and a connecting portion extending away from the central portion, the connecting portion including a wall extending at a non-parallel angle relative to the central portion, and a first reinforcement member including an inner portion defining a plurality of member openings, and an outer portion extending at a non-parallel angle relative to the inner portion, a second tank including a tank wall at least partially defining a cavity and having an end, a second header including a central portion defining a plurality of second header openings, and a connecting portion extending away from the central portion, the connecting portion including a wall extending at a non-parallel angle relative to the central portion, and a second reinforcement member including an inner portion defining a plurality of second member openings, and an outer portion extending at a non-parallel angle relative to the inner portion, the method comprising the acts of:
connecting the outer portion of the first reinforcement member to at least a portion of the wall of the connecting portion of the first header, the outer portion of the first reinforcement member being complementary to the at least a portion of the wall of the connecting portion of the first header;
connecting each first header opening to one opposite end of an associated tube, at least one of the plurality of tubes extending through each first member opening to connect with the first header;
connecting the first header with the first tank to define a first collection tank assembly such that the plurality of tubes is in fluid communication with the first collection tank assembly;
connecting the outer portion of the second reinforcement member to at least a portion of the wall of the connecting portion of the second header, the outer portion of the second reinforcement member being complementary to the at least a portion of the wall of the connecting portion of the second header;
connecting each second header opening to another opposite end of an associated tube, at least one of the plurality of tubes extending through each second member opening to connect with the second header; and
connecting the second header with the second tank to define a second collection tank assembly such that the plurality of tubes is in fluid communication with the second collection tank assembly.
